(19) United States
(12) Patent Application Publication
(10) Pub. No.: US 2007/0143469 A1
(43) Pub. Date: Jun. 21, 2007

(54) Method for identifying and filtering unsolicited bulk email

(75) Inventors: Mark D. Adams, Ann Arbor, MI (US); Philippe-Jacques T. Green, Ann Arbor, MI (US); Theodore J. Green, Ann Arbor, MI (US)

Correspondence Address: HARNESS, DICKEY & PIERCE, P.L.C., P.O. BOX 828, BLOOMFIELD HILLS, MI, 48303, US

(73) Assignee: Greenview Data, Inc., Ann Arbor, MI (US)

(21) Appl. No.: 11/305,744

(22) Filed: Dec. 16, 2005

(51) Int. Cl. G06F 15/173

(52) U.S. Cl. 709/224

(57) ABSTRACT

An improved method is provided for identifying unsolicited bulk email messages. The method includes: monitoring electronic messages being sent to a plurality of recipients; identifying a subset of the electronic messages advertising a particular domain name; assessing reputation of the particular domain name; determining how many recipients received an electronic message from the subset of electronic messages; and deeming the subset of electronic messages to be unsolicited bulk messages when the particular domain name is not reputable and the number of recipients receiving an electronic message from the subset of electronic messages exceeds a threshold.

### FIELD OF THE INVENTION

The present invention relates generally to unsolicited bulk email and, more particularly, to improved automated methods for identifying unsolicited bulk email messages.

### BACKGROUND OF THE INVENTION

Spam is defined as unsolicited bulk email messages. Often times, spam is intended to advertise a product or service that is available for purchase. Accordingly, these types of messages will typically include a method by which the recipient can contact the seller. For instance, spam may include a phone number or an address for the seller. However, it is much more prevalent for spam to include a hyperlink to the seller's website. Once a domain name is deemed to be advertised by, owned by or otherwise associated with a spammer, a content filter may be employed to block subsequent email messages that advertise this domain name from reaching its intended recipients. Of course, not all email messages advertising a domain name are considered spam.

Therefore, it is desirable to provide improved and automated techniques for identifying unsolicited bulk email messages.

### SUMMARY OF THE INVENTION

In accordance with one aspect of the present invention, an improved method is provided for identifying unsolicited bulk email messages. The method includes: monitoring electronic messages being sent to a plurality of recipients; identifying a subset of the electronic messages advertising a particular domain name; assessing reputation of the particular domain name; determining how many recipients received an electronic message from the subset of electronic messages; and deeming the subset of electronic messages to be unsolicited bulk messages when the particular domain name is not reputable and the number of recipients receiving an electronic message from the subset of electronic messages exceeds a threshold. In one exemplary embodiment, the reputation of the particular domain name is assessed by determining how recently the particular domain name was registered with a domain name registrar.

In another aspect of the present invention, the method for identifying unwanted email messages further includes: identifying a domain name associated with an unwanted email message; determining a domain name server associated with the domain name; determining a network address for the domain name server; identifying each domain name server associated with the network address; identifying domain names associated with each of the domain name servers; and deeming any email message advertising an identified domain name as an unwanted email message.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a flowchart illustrating an improved method for identifying unsolicited bulk email messages in accordance with the present invention;

FIG. 2 is a flowchart illustrating another improved method for identifying unsolicited bulk email messages in accordance with the present invention; and

FIG. 3 is a block diagram of a computer-implemented system for identifying and filtering unsolicited bulk messages according to the present invention.

### DETAILED DESCRIPTION OF THE PREFERRED EMBODIMENTS

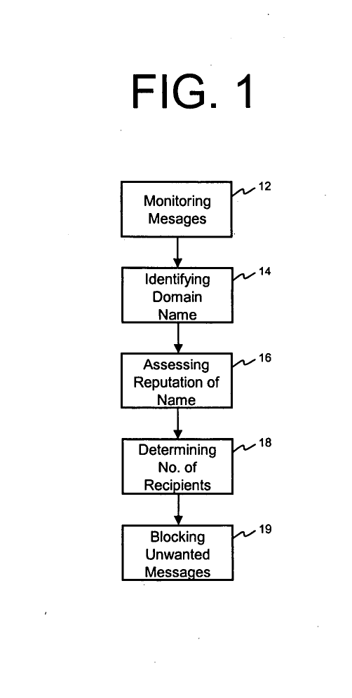

FIG. 1 illustrates an improved and automated method for identifying unsolicited bulk email messages in accordance with the present invention. Briefly, electronic messages are monitored at step 12. A subset of the messages is identified as advertising a particular domain name at step 14. The reputation of the particular domain name is then assessed at step 16. When the domain name is considered not reputable and the number of recipients receiving an electronic message from the subset of electronic messages exceeds a frequency threshold, the subset of electronic messages is deemed to be unsolicited bulk messages (also referred to herein as “spam”). Each of these steps will be further described below.

To understand how spam may be monitored, an explanation is provided as to how email is sent on the Internet. Assume that your email address is john@yourdomain.com and that someone sends you an email message. The sender's server will query the public Domain Name Service (DNS) for the “MX” records for the domain yourdomain.com. The answer to the query will typically consist of a single “MX” record, such as:
yourdomain.com MX priority=10 mail1.bighost.net
   In this example, the domain yourdomain.com is probably being hosted by the company Bighost.net and mail1.bighost.net is the hosting company's mail server. Basically, this record is telling the public that all email for the domain of yourdomain.com should be delivered to the mail server mail.bighost.net, which has been assigned to handle email for the domain.

The sender's mail server then connects to mail1.bighost.net and sends it the message. The Bighost.net mail server then delivers the message locally to your john@yourdomain.com inbox and holds the message until you log in and check your email.

While most domains have just one “MX” record, your domain can have multiple MX records. For example, the MX records for your domain could be:

| | | | |
|---|---|---|---|
| yourdomain.com | MX | priority = 10 | mx1.spamstophere.com |
| yourdomain.com | MX | priority = 20 | mx2.spamstopshere.com |
| yourdomain.com | MX | priority = 20 | mx3.spamstopshere.com |

When a mail server sends email to your domain, it first attempts to send it according to the MX record with the highest (lowest number) priority. If the two servers fail to establish a connection, the sending mail server tries the next highest priority MX record, until it goes through all of the MX records. In the example above, “mx1.spamstopshere.com” has the highest priority and will therefore receive all mail (unless there is a connection failure). This server can be configured to monitor and filter spam before it reaches the recipient's mail server mail1.bighost.net. In this way, messages can be monitored prior to reaching its intended recipient. MX records are but one exemplary way for monitoring messages. It is readily understood that other techniques for monitoring messages are also within the scope of the present invention.

From amongst the monitored messages, a subset of the messages may be advertising a particular domain name. As discussed above, spam will typically include a method by which the recipient can contact the sender. For instance, spam may include a phone number or an address for the sender. However, it is much more prevalent for spam to include a hyperlink which identifies a domain name. In this way, the message advertises a domain name. It is readily understood that a domain name found in other portions of the message (e.g., sender identifier) could also be considered as being advertised by the message. Since all messages advertising a domain name are not spam, these types of messages must be further evaluated.

First, the reputation of an advertised domain name may be assessed. In one exemplary embodiment, how long a domain name has been registered may be used as an indication of the domain's reputation. Domain names must be registered with a publicly accessible registry. Once a domain name is associated with a spammer, a content filter may be used to block messages advertising that domain name. To avoid such filters, spammers will register new domain names on an on-going basis. In contrast, reputable businesses are more likely to promote and maintain the same domain name over a long period of time, thereby building consumer recognition. Thus, how recently a domain name has been registered may provide an indication as to its reputation. For example, a domain name that has been registered within the last thirty (30) days is considered to be non-reputable.

Reputation of a domain name may be assessed in other ways. For instance, does the domain name have the same IP address as a known spammer. An “A” record DNS query for the domain name will yield an IP address for the domain. This IP address is then compared to the IP addresses for all of the domain names previously deemed to be non-reputable. If there is a match, then this domain name may also be deemed non-reputable.

Similarly, a web page for the domain name may be the same as a web page of a known spammer. In this instance, the web page for the domain name is downloaded and a subset of the HTML data is used to compile a unique signature of the site. For comparison purposes, the domain name, along with any HTML comments, are removed from the HTML data. A unique signature of the remaining HTML data is generated using a MD5 checksum algorithm or any other suitable algorithm. This unique signature may then be compared to a database of signatures for web pages of known spammers. If there is a match, then this domain name may be deemed non-reputable. It is readily understood that these techniques may be used independently or in combination. Moreover, it is envisioned that other techniques for assessing the reputation of an advertised domain name are also within the broader aspects of the present invention.

Second, how prevalent messages advertising a given domain name are amongst the monitored messages is also assessed. For example, if a message advertising a given domain name is sent to more than a predefined number of recipients over a given period of time, it may be presumed to be bulk email. To provide a more reliable assessment, these two factors are combined. In other words, a message advertising a given domain name is deemed to be an unsolicited bulk message when the domain name is considered not reputable and the number of recipients receiving the message exceeds some threshold.

In some instances, anti-spam filtering services may be provided by a third party service to more than one entity, such that the third party monitors messages being sent to the different mail servers of each entity. When a message advertising the given domain name is sent to different entities, this may serve as a further indication that the domain name is associated with bulk email. Therefore, determining the number of different mail servers and/or the number of different entities a message is sent to may provide an additional metric for assessing messages. This metric may be used in combination with the two metrics described above. It is readily understood that other metrics may also be used in place of or in conjunction with these metrics to assess whether a message advertising a domain name is spam.

Thus, an improved method for identifying bulk email messages has been set forth above. In this method, domain names can be more reliably associated with spammers without human intervention. Once a domain name is deemed to be associated with a spammer, the domain name can then be automatically added to a list of spam domains and thus blocked by a content filter from reaching intended recipients. As a result, domain names are added to the content filter earlier in a spam campaign, thereby improving the effectiveness of content filtering techniques.

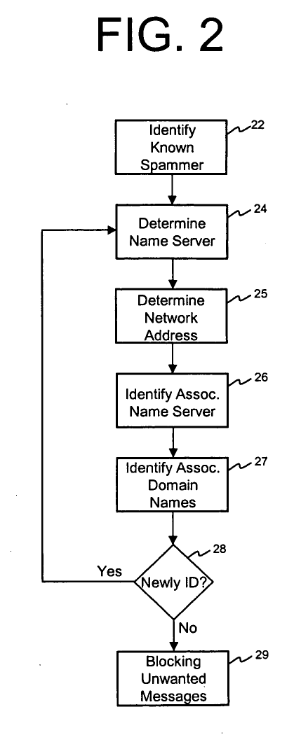

Large spam operations typically run their own domain name servers to resolve their domain names. In some instances, this type of operation enables domain names associated with known spammers to be identified prior to receiving messages advertising the domain name. A method for identifying such unwanted email messages is further described below in relation to FIG. 2.

To identify a spammer, email messages are monitored in the manner described above. For amongst the monitored messages, one or more of the messages may be advertising a domain name and identified as spam as shown at step 22. Messages may-be deemed to be spam using the method set forth in FIG. 1 or some other suitable technique for identifying unwanted bulk messages. For each identified spam message, the domain being advertised in the message can be further analyzed by using a spidering technique to identify other domain names and/or domain name servers associated with the known spammer.

By policy, root zone files for top level domains are available upon request. A root zone file contains a list of all the second level domains falling under the top level domain. The root zone file further includes the authoritative name servers for each second level domain and an IP address for each name server under that top level domain. For known spammers, the root zone file can be used to identify domain names and name servers associated with the spammer as indicated at step 24.

For example, if the domain name “foo.com” was seen in an email message from a known spammer, the name servers for this domain name might be listed as the following:

ns1.bar.com

ns2.bar.com

Since the name server could be a legitimate company hosting only a few spammers, each name server is evaluated to determine if it is associated with a known spammer.

One technique for evaluating a name server is described below. At some periodic time interval, a database is compiled of every name server under each top level domain. A count is maintained as to how many domains use each name server and of these domains how many are known spammer domains. An exemplary database may be:

| Name Server | # Domains | # spammers |
|---|---|---|
| Ns1.yahoo.com | 100,000 | 40 |
| Ns1.foobar.com | 1,000 | 650 |

Form this data, a ratio may be calculated of known spammer domains to total domains hosted by the name server. In this example, ns1.yahoo.com has a 0.04% ratio of spammers to hosted domains; whereas, ns1.foobar.com has a 65% ratio of spammers to hosted domains. A name server may be deemed associated with a spammer when this ratio exceeds some defined threshold. For example, given a threshold of 60%, ns1.foobar.com is deemed to be a spammer. It is readily understood that other techniques for evaluating a name server are within the broader aspects of the present invention.

When a name server is deemed to be associated with a known spammer, parsing the root zone file for all of the second level domains for all entries that contain the name servers of the spammer could result in finding many domain names registered to the same spammer:

foo.com=ns1.bar.com

bar.net=ns1.bar.com

foobar.biz=ns2.bar.com

The domain “foo.com” would have been added to the content filter earlier, but the domains “bar.net” and “foobar.biz” could be added to the content filter prior to receiving an email advertising these domain names. When the spammer got around to sending spam which advertises the new domain names, the spam would be blocked preemptively. Using this method allows filtering based on domain names to be proactive instead of reactive.

Some spammers have made this method of finding their domain names difficult by using a domain name which is found in the name of the name server. For example, the spam may advertise “foo.com”, with the name servers “ns1.foo.com” and “ns2.foo.com”. When parsing the root zone files, no other domain names are registered with these name servers. Although the spammer also owns “bar.net”, the name servers for that domain are actually “ns1.bar.net” and “ns2.bar.net”.

Another technique may be employed to track these spammers. Using the root zone file, the IP address for “ns1.foo.com” can be determined at step 25 and all of the name servers could be found at step 26 using this IP address:

ns1.bar.com=1.2.3.4

ns1.bar.net=1.2.3.4

ns1.foobar.biz=1.2.3.4

At step 27, the newly found name servers could then be used to find new domain names associated with the spammer.

For each newly identified domain name, the above-described process is repeated as indicated at step 28. Once this process is exhausted, identified domain names and domain name servers associated with the known spammer may be added to content filters or otherwise used to block delivery of unwanted bulk email messages as shown at step 29.

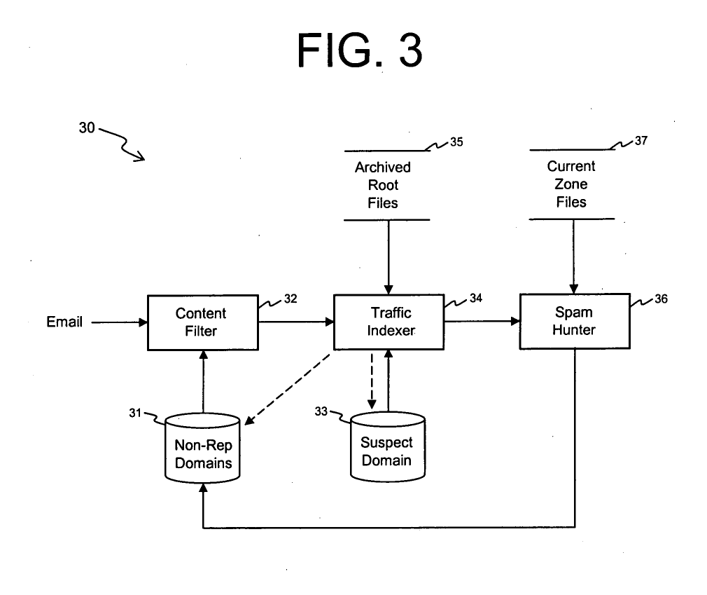

FIG. 3 depicts a computer-implemented system 30 for identifying and filtering unsolicited bulk messages in accordance with the present invention. The system is comprised generally of a content filter 32, a traffic indexer 34 and a spam hunter 36. Each of these software modules is further described below.

In general, a content filter 32 is operable to block unwanted email messages from reaching intended recipients. In operation, the content filter 32 may be adapted to receive and monitor email messages through the use of MX records as described above. For each message, the content filter 32 parses the message text in accordance with a predefined rule set. In one instance, the content of the email message is reviewed for hyperlinks or any other references to a domain name. Each identified domain name is then compared to a list of spam domain names 31. When an identified domain name is found on the list of spam domain names 31, the messages may be discarded by the content filter 32 and thereby blocked from reaching its intended recipient.

An identified domain name which is not found on the list of spam domain names 31 is passed on to a traffic indexer 34 for further assessment. The traffic indexer 34 first determines the domain's reputation using the method described above or other suitable techniques. When the identified domain name is found to be non-reputable, the domain is put on a suspect list and a counter of unique recipients or recipient groups associated with the domain name is incremented. In this way, the number of intended recipients may be monitored. Until this counter reaches some predefined threshold, an email message containing the identified domain name is delivered to its intended recipient. Once the counter exceeds the threshold, the domain name may be removed from the list of suspected domain names 33 and placed on the list of spam domain names 31. In other words, the email message is deemed to be spam and thus will not be delivered to its intended recipient.

In an alternative approach, when the identified domain name is found in the list of suspected domain names, the counter is incremented, but delivery of the message is delayed for a defined period of time. If the timer expires before the counter exceeds the threshold, then the message is delivered to its intended recipient. However, if the counter exceeds the threshold before the timer expires, then the messages are not delivered, thereby further reducing the spam which reaches these intended recipients.

When the identified domain name is not found in the list of suspected domain names 33, it may be evaluated for insertion onto the list. In an exemplary embodiment, an identified domain name is added to the list of suspected domain names 33 when is has been recently registered with a registrar. To determine if a domain name has been recently registered, the traffic indexer 34 downloads zone files 35 for each top level domain on a daily basis. The zone files 35 are then archived over a defined period of time (e.g., 30 days). Thus, an identified domain can be compared by the traffic indexer 34 to the applicable zone file (i.e., the file archived thirty days ago). If the identified domain name is not found in the archived zone file, it must have been recently registered and thus is added to the list of suspected domain names. It is envisioned that other techniques may be employed to determine when a domain name was added to the registry.

When an email message is deemed to be spam, the domain name advertised there will also be passed on to the spam hunter 36 for further assessment. The spam hunter 36 in turn implements the spidering technique described above to identify other domain names and/or domain name servers associated with the known spammer. Identified domain names and domain name servers may then be inserted onto the list of spam domains for use by the content filter 32.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of identifying unsolicited bulk email messages, comprising:
monitoring electronic messages being sent to a plurality of recipients;
identifying a subset of the electronic messages advertising a particular domain name;
assessing reputation of the particular domain name;
determining how many recipients received an electronic message from the subset of electronic messages; and
deeming the subset of electronic messages to be unsolicited bulk messages when the particular domain name is not reputable and the number of recipients receiving an electronic message from the subset of electronic messages exceeds a frequency threshold.

2. The method of claim 1 further comprises blocking the subset of electronic messages from reaching intended recipients.

3. The method of claim 1 wherein assessing reputation of the particular domain name further comprises determining how recently the particular domain name was registered with a domain name registrar.

4. The method of claim 3 further comprises deeming the subset of electronic messages to be unsolicited bulk messages when the particular domain name advertised in the subset of electronic messages has been registered within a period of time and the number of recipients receiving an electronic message from the subset of electronic messages exceeds a frequency threshold.

5. The method of claim 1 wherein assessing reputation of the particular domain name further comprises determining an IP address for the particular domain name and comparing the IP address to a list of known non-reputable IP addresses.

6. The method of claim 1 wherein assessing the reputation of the particular domain name further comprises retrieving a web page associated with the particular domain name, determining a signature based on content of the web page, and comparing the signature to a compilation of signatures for web pages associated with known spammers.

7. The method of claim 1 wherein assessing reputation of the particular domain name further comprises determining a domain name server associated with the particular domain name and comparing the domain name server to a list of known non-reputable domain name servers.

8. The method of claim 1 further comprises determining how many recipients received an electronic message from the subset of electronic messages within a period of time.

9. The method of claim 1 further comprises determining how many different groups of associated recipients received an electronic message from the subset of electronic messages, where the plurality of recipients are grouped into groups of associated recipients, and deeming the subset of electronic messages to be unsolicited bulk messages when the particular domain name is not reputable and the number of different groups receiving an electronic message from the subset of electronic messages exceeds a frequency threshold.

10. A method of identifying unsolicited bulk email messages, comprising:
monitoring electronic messages being sent to a plurality of recipients;
identifying a subset of the electronic messages advertising a particular domain name;
determining if the particular domain name was registered with a domain name registrar within a period of time;
determining how many recipients received an electronic message from the subset of electronic messages; and
deeming the subset of electronic messages to be unsolicited bulk messages when the particular domain name advertised in the subset of electronic messages has been registered within the defined period of time and the number of recipients receiving an electronic message from the subset of electronic messages exceeds a frequency threshold.

11. The method of claim 10 further comprises blocking the subset of electronic messages from reaching intended recipients.

12. The method of claim 10 further comprises placing the particular domain name on a list of spam domain names.

13. The method of claim 10 wherein determining if the particular domain name was registered with a domain name registrar further comprises archiving zone files for each top level domain on a daily basis and determining if the particular domain name resides in a zone file which corresponds to the period of time.

14. The method of claim 10 further comprises determining how many different groups of associated recipients received an electronic message form the subset of electronic messages, where the plurality of recipients are grouped into groups of associated recipients, and deeming the subset of electronic messages to be unsolicited bulk messages when the particular domain name is not reputable and the number of different groups receiving an electronic message from the subset of electronic messages exceeds a frequency threshold.

15. A method for identifying unwanted email messages, comprising:
(a) identifying a domain name associated with an unwanted email message;
(b) determining a domain name server associated with the domain name;
(c) determining a network address for the domain name server;
(d) identifying each domain name server associated with the network address;
(e) identifying domain names associated with each of the domain name servers; and
(f) deeming any email message advertising an identified domain name as an unwanted email message.

16. The method of claim 15 further comprises repeating steps (b) thru (f) for each newly identified domain name.

17. The method of claim 15 further comprises blocking email messages advertising an identified domain name from reaching intended recipients.

18. The method of claim 15 further comprises blocking email messages advertising domain names associated with any of the identified domain name servers

19. The method of claim 15 further comprises placing the identified domain names on a list of spam domain names.

20. The method of claim 15 wherein identifying a domain name associated with an unwanted email message further comprises:
monitoring electronic messages being sent to a plurality of recipients;
identifying a subset of the electronic messages advertising a particular domain name;
determining if the particular domain name was registered with a domain name registrar within a period of time;
determining how many recipients received an electronic message from the subset of electronic messages; and
deeming the subset of electronic messages to be unsolicited bulk messages when the particular domain name advertised in the subset of electronic messages has been registered within the defined period of time and the number of recipients receiving an electronic message from the subset of electronic messages exceeds a frequency threshold.

21. The method of claim 15 wherein determining a domain name server associated with the domain name and determining a network address for the domain name server further comprises accessing root zone files for each top level domain.
